(19) United States
(12) Patent Application Publication
(10) Pub. No.: US 2022/0325742 A1
(43) Pub. Date: Oct. 13, 2022

(54) COATED FASTENER BODY

(71) Applicant: MacLean-Fogg Company, Mundelein, IL (US)

(72) Inventors: Mark RAVES, Mundelein, IL (US); Luke Michael ROBERTS, Madison Heights, MI (US)

(73) Assignee: MacLean-Fogg Company, Mundelein, IL (US)

(21) Appl. No.: 17/716,979

(22) Filed: Apr. 8, 2022

Related U.S. Application Data
(60) Provisional application No. 63/172,285, filed on Apr. 8, 2021.

(51) Int. Cl. F16B 33/06; B60B 3/16

(52) U.S. Cl. CPC F16B 33/06; B60B 3/16

(57) ABSTRACT

A wheel fastener and method of forming a wheel fastener is provided. The wheel fastener has a fastener body with a threaded portion, a wrenching portion and a spherical load-bearing portion is configured to mate with a fastener seat on a wheel, where the spherical radius is in the range of 13.9 mm to 14.0 mm. The fastener also includes a multi-layer coating is applied to the fastener body, the multi-layer coating having a friction topcoat with a coefficient of friction in the range of 0.10 to 0.20. The fastener also includes a cap secured on the wrenching portion and defining a wrenching surface.

### CROSS-REFERENCE TO RELATED APPLICATIONS

This application claims the benefit of U.S. provisional application Ser. No. 63/172285 filed Apr. 8, 2021, the disclosure of which is hereby incorporated in its entirety by reference herein.

### BACKGROUND

The present invention relates generally to fasteners and more particularly to wheel fasteners.

### SUMMARY

According to at least one embodiment, a wheel fastener is provided with a fastener body having a threaded portion, a wrenching portion and a spherical load-bearing surface portion is configured to mate with a fastener seat on a wheel, where the spherical radius is in the range of 13.9 mm to 14.0 mm. The fastener also includes a multi-layer coating is applied to the fastener body, the multi-layer coating having a friction topcoat with a coefficient of friction in the range of 0.10 to 0.20. The fastener also includes a cap secured on the wrenching portion and defining a wrenching surface.

In another embodiment, the wheel fastener where the fastener body has a flange adjacent the spherical load-bearing surface portion, where an edge of the cap is crimped along the bolt flange.

In another embodiment, the fastener body is formed as a wheel bolt having the threaded portion formed at a first end, and the wrenching portion formed at a second end, where the spherical load-bearing portion is formed adjacent the threaded portion, and the flange is formed adjacent the wrenching portion.

In another embodiment, spherical radius is in the range of 13.95 mm to 10 mm. The spherical load-bearing surface portion extends at least between a first gage diameter being 23 mm and a second gage diameter being 15 mm.

In another embodiment, the spherical load-bearing surface of the fastener body has a spherical radius with a positional tolerance in the range of 0/−0.1 millimeters. In another embodiment, the spherical load-bearing surface of the fastener body has a positional tolerance in the range of 0/−0.05 millimeters. In another embodiment, the spherical load-bearing surface of the fastener body has a spherical radius with a positional tolerance in the range 0.3% to 0.8%.

In another embodiment, the wheel fastener has a decorative cap covering a wrenching surface and not covering the load-bearing surface.

In another embodiment, the coefficient of friction is in the range of 0.11 to 0.17.

In another embodiment, the cap is formed of stainless steel.

In another embodiment, the cap does not include the multi-layer coating. The cap has a decorative coating being different than the multi-layer coating.

In another embodiment, the multi-layer coating includes a corrosion resistant basecoat being a zinc-aluminum organic paint providing corrosion resistance.

In another embodiment, the multi-layer coating may include a magni568 coating having at least two corrosion-resistant basecoats and the topcoat. The multi-layer coating is a corrosion resistant basecoat and the friction topcoat.

According to at least one embodiment, a wheel assembly may include: at least one fastener a wheel defining at least one fastener opening with a spherical fastener seat to mate with the spherical load-bearing surface portion of the fastener body.

In another embodiment, the fastener has a maximum diameter to ensure a minimum clearance between the fastener body and the fastener opening.

According to at least one embodiment, a method of producing a fastener is provided. The method includes forming a fastener body with a threaded portion, a wrenching portion and a spherical load-bearing surface portion configured to mate with a fastener seat in a wheel. The method also includes coating the fastener body with a corrosion-resistant basecoat. The method also includes coating the fastener body with a multi-layer coating having a corrosion-resistant basecoat and a topcoat with a coefficient of friction in the range of 0.10 to 0.20. The method also includes pre-forming a cap with a wrenching surface. The method also includes securing the cap to the wrenching portion of the fastener body after the fastener body is coated so the cap does not have the multi-layer coating.

In another embodiment, securing the cap may include crimping the cap to the fastener body.

In another embodiment, the multi-layer coating has a thickness of at least 13 microns.

### BRIEF DESCRIPTION OF THE DRAWINGS

FIG. 1 illustrates a wheel fastener according to one embodiment.

FIG. 2 illustrates a wheel fastener a detailed view of the bearing surface of the fastener in FIG. 1.

FIG. 3 illustrates a torque-tension evaluation of a wheel fastener of FIG. 1 having a coating according to one embodiment.

FIG. 4 illustrates a wheel fastener of FIG. 1 mating with a wheel seat.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

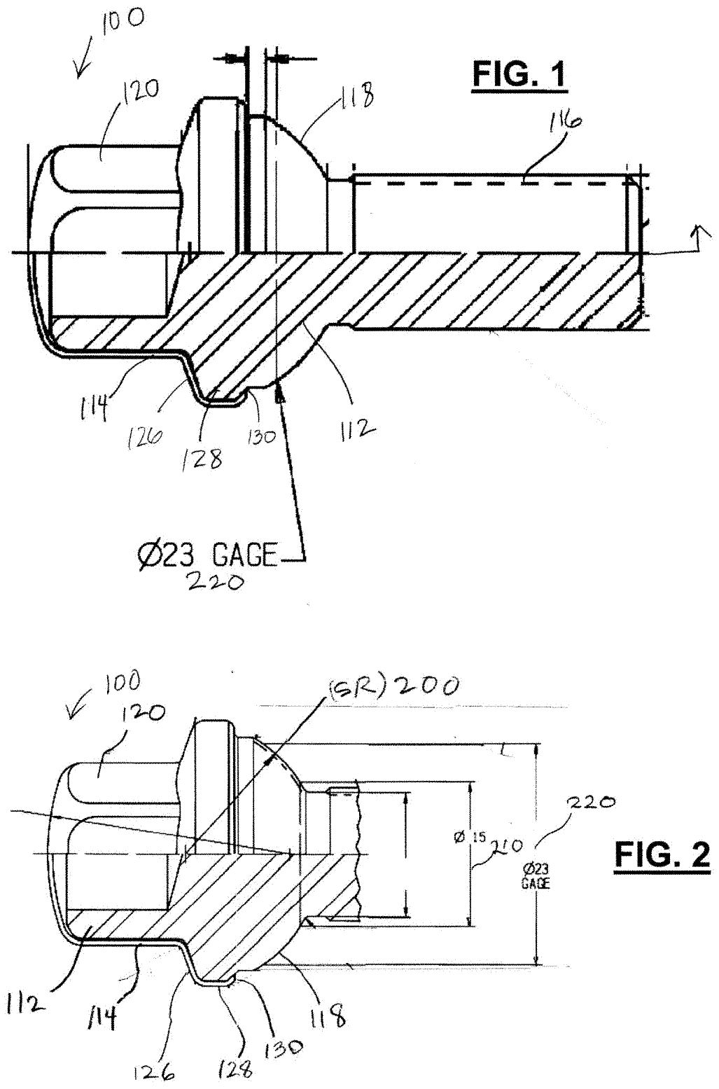

FIG. 1 illustrates a capped fastener, in particular an automotive wheel bolt 100. In this embodiment the capped fastener is a wheel bolt and the threaded portion 116 defines an external thread. The wheel bolt 100 includes a bolt body 112 and cap 114. The bolt body 112 has a threaded portion 116 centered about a longitudinal axis A. The load-bearing surface 118 extends outward radially from the threaded portion 116. As illustrated, the load-bearing surface 118 is spherically shaped.

The fastener body 112 has a wrenching surface 120. As illustrated, the wrenching surface may be hexagonal in shape, and which defines a set of six wrench flats designed to accept torque from a tool such a lug-wrench or hexagonal tool. A shelf 126 extends radially from the wrenching surface 120 to define a flange 128. The cap 114 is shaped generally to conform to the wrenching surface 120 and is secured to the shelf 126 and the flange 128. Thus, the cap 114 also defines an outer wrenching surface 120, as shown in FIG. 1. Other suitable torque-bearing surfaces such as a different polygonal shape with a different number of wrenching surfaces or, any suitable shape, configuration or standard of tool wrenching surface may be used. In one example, the fastener may have a three-point torque-bearing surface such as U.S. patent application Ser. No. 15/487,805 by Wilson et al., or a hybrid three-point torque-bearing surface, such as in U.S. patent application Ser. No. 15/872,386 by Tomaszewski et al., the disclosures of which are hereby incorporated by reference herein. Other suitable torque-bearing surfaces may also be formed on the fastener body 12. The fastener assembly 10 may also have an improved wrenching design and torque bearing surface according to U.S. Pat. No. 8,491,247 by Wilson, the disclosure of which is hereby incorporated by reference herein. The cap 14 may have a decorative wrenching surface that matches the size and styling of the exiting wheel fasteners, but the cap will rotate separately to the fastener and applying torque to the wrenching surface on the cap will not remove the fastener or may not affect tension in the joint, such as in U.S. Patent Application No. 63/315,434 by Deeds et al., or U.S. Patent Application No. 63/296,422 by Raves et al., the disclosures of which are hereby incorporated by reference herein.

The cap 114 may have a decorative coating, such as black coating as described in International Patent Application No. PCT/US22/22811 by MacLean Fogg Company, the disclosure of which is hereby incorporated by reference herein.

The cap 114 is crimped around the flange 128 and is secured into engagement with an undercut 130 on the fastener body 112. The cap 114 is axially retained in on the fastener body 112 such as described in U.S. Pat. Nos. 6,957,939 and 9,937,746 or in U.S. Patent Publication No. 2016/0208844 by MacLean Fogg Company, the disclosures of which are hereby incorporated by reference. The cap 114 may be crimped and secured on the fastener body 112 so that forces exerted along the wrenching surface 120 cannot act to dislodge the cap 114. The cap 114 may be secured on the fastener body 112 without any welding attachment or any adhesive attachment between the cap 114 and the fastener body 112.

In another embodiment, the fastener body may be a nut body having a threaded portion defined as an internal thread.

The fastener body 112 may be cold formed of a metal such as a low or medium carbon steel or suitable material. In at least one embodiment, the fastener body 112 may have a core hardness of HV285-340 and a surface hardness of HV260-370. The HV hardness variation between the surface on the core may be within 30 points.

The cap 114 may be made of a sheet metal such as stainless steel, such as 304SS or 436SS. The cap 114 may also be formed of other suitable materials.

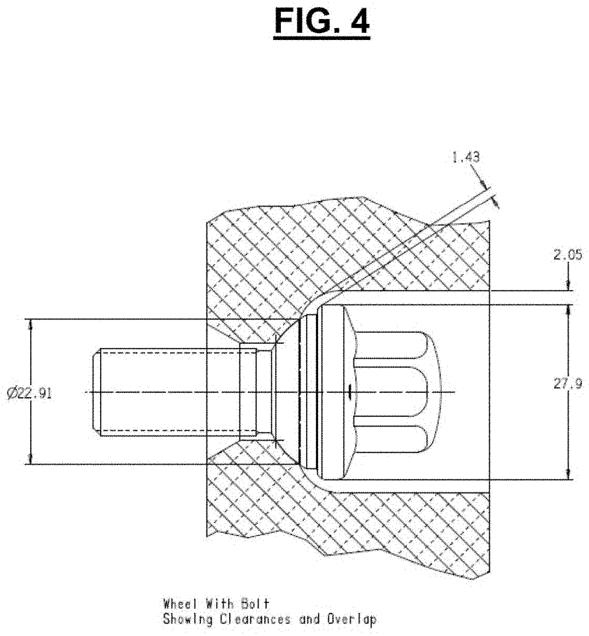

The fastener body 112 may have a coating. The coating may be applied to the fastener body 112 before the cap 114 is secured to the fastener body 112. Prior coatings did not meet the torque-friction requirements when used with a fastener having a spherical load bearing surface and the mating wheel seat, shown in FIG. 4. A coating was developed to provide a coefficient of friction that allowed the wheel bolts 100 to maintain adequate tension when installed at a required torque. In one embodiment, the wheel bolt seat is formed of aluminum.

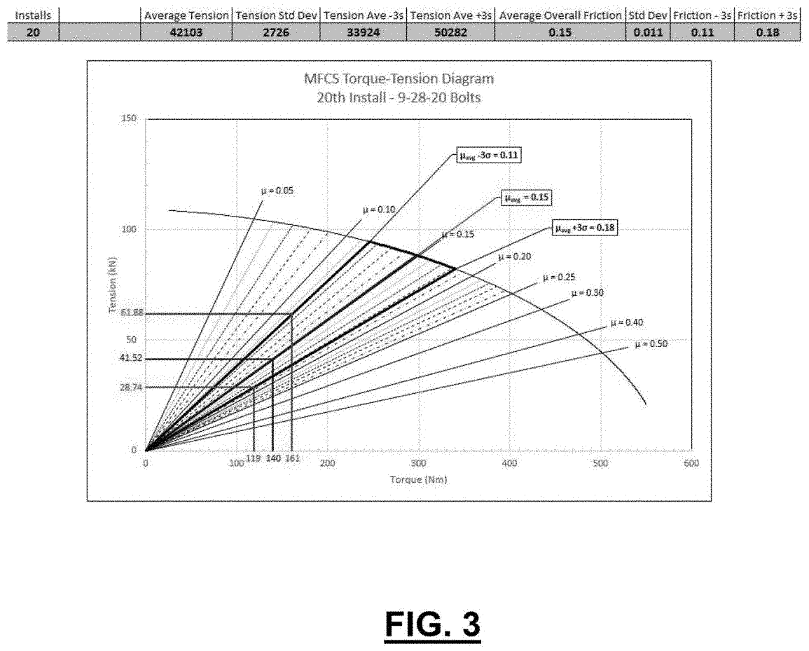

FIG. 3 illustrates an example of the torque-tension evaluation of a fastener 100. The coefficient of friction along the coated spherical load-bearing surface 118 may be in the range of 0.10 and 0.20 when the fasteners are torqued to 140 Nm. In another embodiment, the coefficient of friction along the coated spherical load-bearing surface 118 is in the range of 0.11 and 0.17 to ensure required tension at the applied torque when accounting for tolerances of the fastener body and fastener seat.

The requirements for coefficient of friction are achieved with a coating applied to the fastener body 112 along the load-bearing surface 118 and the threaded portion 116. For example, the coating may be a chrome-free, zinc aluminum composite coating designed to meet the corrosion and friction performance requirements. The coating may have multiple layers to provide adequate coverage and chemical protection. The coating layers may include three layers include two basecoats and one topcoat. In one example, the coating may be a Magni™ 568 coating having two basecoats being a BO6JA, zinc-aluminum organic paint providing corrosion resistance. The topcoat has a specially designed integrated friction modifier to provide the specified coefficient of friction between the load-bearing surface and a wheel bolt seat.

The basecoat may have a minimum coating thickness of at least 8 microns. The topcoat may have a minimum coating thickness of at least 5 microns. The minimum coating thickness may be at least 13 microns. The coating layers may be applied using dip-spin or spray application, or other suitable methods. Shot blast and/or phosphate cleaning may be used between the coating layers.

The dimensions and tolerances of the spherical load-bearing surface 118 are also critical in achieving the desired torque-tension characteristics of the coated fastener 100. The application of the coating layers may cause a non-uniform surface. As such, the dimension of the spherical load-bearing surface 118 prior to coating is critical to maintain the required post-coating specifications for coefficient of friction.

For example, the spherical radius 200 of the load-bearing surface 118 is a critical dimension. The spherical radius 200 along the entire load-bearing surface may have a position tolerance of 0/−0.1 mm. For example, for a nominal spherical radius of 14.0 mm, the spherical radius has a position tolerance the range of 13.9 mm and 14.0 mm. In another embodiment, the spherical radius 200 may have a position tolerance of 0/−0.05 mm where a nominal spherical radius of 14.00 mm is in the range of 13.95 mm and 14.0 mm. In a further embodiment may have a spherical radius that has a positional tolerance of 0.3% to 0.8%. As shown in FIG. 2, the spherical radius 200 is measured at a first gage position 210 and a second gage position 212. Traditional tolerances allow greater variability which allow for greater ease in manufacturing and lower cost. However, the relaxed tolerance does not ensure the fasteners achieve and maintain adequate tension with the wheel seat with the coating.

FIG. 4 illustrates a wheel fastener of FIG. 1 mating with a wheel seat and showing the clearances and overlap. A distance between the spherical load-bearing surface 118 and the flange 128 maintains a clearance between the fastener 100 and wheel seat.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wheel fastener comprising:
a fastener body having a threaded portion, a wrenching portion and a spherical load-bearing surface portion is configured to mate with a fastener seat on a wheel, wherein a spherical radius is in the range of 13.9 mm to 14.0 mm;
a multi-layer coating is applied to the fastener body, the multi-layer coating having a friction topcoat with a coefficient of friction in the range of 0.10 to 0.20; and
a cap secured on the wrenching portion and defining a wrenching surface.

2. The wheel fastener of claim 1, wherein the fastener body has a flange adjacent the spherical load-bearing portion, wherein an edge of the cap is crimped along the flange.

3. The wheel fastener of claim 2, wherein the fastener body is formed as a wheel bolt having the threaded portion formed at a first end, and the wrenching portion formed at a second end, wherein the spherical load-bearing portion is formed adjacent the threaded portion, and the flange is formed adjacent the wrenching portion.

4. The wheel fastener of claim 1, wherein the spherical radius is in the range of 13.95 mm to 14.0 mm.

5. The wheel fastener of claim 1, wherein the spherical load-bearing portion extends at least between a first gage diameter being 23 mm and a second gage diameter being 15 mm.

6. The wheel fastener of claim 1, wherein the coefficient of friction is in the range of 0.11 to 0.17.

7. The wheel fastener of claim 1, wherein the cap is formed of stainless steel.

8. The wheel fastener of claim 1, wherein the cap does not include the multi-layer coating.

9. The wheel fastener of claim 1, wherein the cap has a decorative coating being different than the multi-layer coating.

10. The wheel fastener of claim 1, wherein the multi-layer coating includes a corrosion resistant basecoat being a zinc-aluminum organic paint providing corrosion resistance.

11. The wheel fastener of claim 10, wherein the multi-layer coating comprises a Magni™ 568 coating having at least two corrosion-resistant basecoats and the friction topcoat.

12. The wheel fastener of claim 10, wherein the multi-layer coating a corrosion resistant basecoat and the friction topcoat.

13. A wheel assembly comprising:
at least one fastener according to claim 1;
a wheel defining at least one fastener opening with a spherical fastener seat to mate with the spherical load-bearing surface portion of the fastener body.

14. The wheel assembly of claim 13, wherein the wheel has a maximum diameter to ensure a minimum clearance between the fastener body and the fastener opening.

15. A method of forming a wheel fastener, the method comprising:
forming a fastener body with a threaded portion, a wrenching portion and a spherical load-bearing portion configured to mate with a fastener seat in a wheel;
coating the fastener body with a corrosion-resistant basecoat;
coating the fastener body with a multi-layer coating having a corrosion-resistant basecoat and a topcoat with a coefficient of friction in the range of 0.10 to 0.20;
pre-forming a cap with a wrenching surface;
securing the cap to the wrenching portion of the fastener body after the fastener body is coated so the cap does not have the multi-layer coating.

16. The method of claim 15, wherein securing the cap comprises crimping the cap to the fastener body.

17. The method of claim 16, wherein the fastener body has a flange, and the cap is crimped around the flange.

18. The method of claim 15, wherein the spherical load-bearing portion of the fastener body has a spherical radius with a positional tolerance in the range of +0 to −0.1 millimeters.

19. The method of claim 15, wherein the multi-layer coating has a thickness of at least 13 microns.

20. The method of claim 15, wherein the coefficient of friction is in the range of 0.11 to 0.17
